(19) United States
(12) Patent Application Publication
(10) Pub. No.: US 2019/0177213 A1
(43) Pub. Date: Jun. 13, 2019

(54) Multi-Layer Photo Definable Glass with Integrated Devices

(71) Applicant: 3D GLASS SOLUTIONS, INC., Albuquerque, NM (US)

(72) Inventors: Jeb H. Flemming, Albuquerque, NM (US); Jeff A. Bullington, Albuquerque, NM (US)

(21) Appl. No.: 16/072,828

(22) PCT Filed: Jan. 25, 2017
(86) PCT No.: PCT/US2017/014977

§ 371 Date: Jul. 25, 2018

Related U.S. Application Data
(60) Provisional application No. 62/289,302, filed on Jan. 31, 2016.

(51) Int. Cl. C03C 17/10; C04B 41/88

(52) U.S. Cl. CPC C03C 17/10; C04B 41/88; C03C 2217/255; C03C 2217/256; C03C 2217/253; C03C 2218/32

(57) ABSTRACT

The invention relates to eliminating or dramatically reducing the mechanical distortion induced in photo-definable glass as a function of temperature and time processing during metallization that enable multi-layer and single layer photo-definable structures, that can contain electronic, photonic, or MEMS devices to create unique vertically integrated device or system level structures.

### TECHNICAL FIELD OF THE INVENTION

Photo-definable glass-ceramic has a mechanical distortion during processing as a function of temperature and time. The present invention relates to creating multi-layer and single layer photo-definable structures, that can contain electronic, photonic, or MEMS devices to create unique vertically integrated devices or system level structures that virtually eliminate mechanical distortions that result from metallization.

### BACKGROUND ART

Photosensitive glass structures are being used for a number of micromachining and microfabrication processes such as integrated electronic photonics and MEMs devices in conjunction with other elements systems or subsystems on a planer structure. Over the last number of years, to achieve higher performance and packing densities, the packaging industry has been integrating multiple layers of silicon devices connected through metal filled via, epoxies and other elements in conjunction with thermal and/or UV curing processes. To date, all photo-definable glasses have feature migration as a function temperature cycling that, if not controlled, randomly moves the previously created device structures in the glass.

Photo-definable glass ceramic (APEX®) or other photo definable glass as a novel substrate material for semiconductors, RF electronics, microwave electronics, electronic components and/or optical elements. In general, a photo definable glass is processed using first generation semiconductor equipment in a simple three step process and the final material can be fashioned into either glass, ceramic, or contain regions of both glass and ceramic. A photo definable glass ceramic possesses several benefits over current materials, including: easily fabricated high density vias, demonstrated microfluidic device capability, micro-lens or micro-lens array, transformers, inductors transmission lines, and many other devices. Photo-sensitive glasses have several advantages for the fabrication of a wide variety of microsystems components. Microstructures have been produced relatively inexpensively with these glasses using conventional semiconductor or PC board processing equipment. In general, glasses have high temperature stability, good mechanical and electrical properties, and have better chemical resistance than plastics and many metals. Another form of photo-sensitive glass is FOTURAN®, made by Schott Corporation. FOTURAN® comprises a lithium-aluminum-silicate glass containing traces of silver ions plus other trace elements specifically silicon oxide (SiO₂) of 75-85% by weight, lithium oxide (Li₂O) of 7-11% by weight, aluminum oxide (Al₂O₃) of 3-6% by weight, sodium oxide (Na₂O) of 1-2% by weight, 0.2-0.5% by weight antimonium trioxide (Sb₂O₃) or arsenic oxide (As₂O₃), silver oxide (Ag₂O) of 0.05-0.15% by weight, and cerium oxide (CeO₂) of 0.01-0.04% by weight. As a photo-definable glass is cycled to high temperature, glass transformation temperature (e.g., greater than 465° C. in air for FOTURAN®) it experience a color shift from transparent to yellow. This measureable color shift is directly related to the time and temperature. The higher the temperature and the longer the time the greater the color shift. The color shift makes is an easy method to determine the thermal cycle history of a fully processed photo-definable glass.

When exposed to UV-light within the absorption band of cerium oxide the cerium oxide acts as sensitizers, absorbing a photon and losing an electron that reduces neighboring silver oxide to form silver atoms, e.g.,

Ce³⁺+Ag⁺=□Ce⁴⁺+Ag⁰

The silver atoms coalesce into silver nanoclusters during the baking process and induce nucleation sites for crystallization of the surrounding glass. If exposed to UV light through a mask, only the exposed regions of the glass will crystallize during subsequent heat treatment.

This heat treatment must be performed at a temperature near the glass transformation temperature (e.g., greater than 465° C. in air for FOTURAN®). The crystalline phase is more soluble in etchants, such as hydrofluoric acid (HF), than the unexposed vitreous, amorphous regions. In particular, the crystalline regions of FOTURAN® are etched about 20 times faster than the amorphous regions in 10% HF, enabling microstructures with wall slopes ratios of about 20:1 when the exposed regions are removed. See T. R. Dietrich et al., “Fabrication technologies for microsystems utilizing photo-sensitive glass,” Microelectronic Engineering 30, 497 (1996), which is incorporated herein by reference.

The act of converting the photo definable glass to near the glass transformation temperature (e.g., greater than 465° C. in air for FOTURAN®) facilitate etching and formation of complex three dimensional structures for induces a permanent mechanical distortion in the substrate. These random distortions can be as large as 400 μm. Distortions greater than tens of microns prevent the alignment of integral electronic elements including: vias, bonding pads, interconnect, fiber alignments, sensors and other integrated devices making the device virtually impossible to successfully integrate with other packaging elements. The distortion, created by processing photo definable glass to near the glass transformation temperature, can be successfully controlled with composition as demonstrated by APEX® Glass. Even the compositional changes from APEX® Glass are unable to prevent the mechanical distortion associated with copper paste metallization.

Various forms of metal pastes can be used for metallization of glass, ceramic or other substrates. These metal pastes include: silver, gold, and copper. All though all of these metal pastes will work for the application, copper paste metallization has become the industry standard due to both cost and performance, plus historical packaging and processing technology. Unfortunately, copper paste metallization has a temperature processing range and time profile up to 600° C. for up to an hour. These times and temperatures induce a random shift in the physical dimensions of each glass substrate making it impossible to align structures or create structures between other glass layers, bonding pads or other packaging elements. As a result, the ability to package a glass substrate with copper paste metallization is impossible. However, multiple thermal cycles exacerbate the random thermal creep and induces an optical change to the transmission of all photo-definable glass even the compositionally stabilized photo-definable glass. This invention provides for a cost effective method to produce copper paste metalized photo-definable glass either as a single layer or multiple layer of photo-definable glass structure minimizing and/or eliminating the thermal creep, thus enabling reliable single/multi-level vertical interconnects and monolithic device and copper paste metallization. The mechanical distortion can enable multi-level device structures having one or more parts of the device contained on separate photo-definable glass layers.

### DISCLOSURE OF THE INVENTION

The present invention includes a method to fabricate a multi-layer and single layer photo-definable structures, that can contain electronic, photonic, or MEMS with copper metallization. The multi-layer structure enables the interface of two or more photo-definable glass wafers with reliable multi-level vertical interconnects and monolithic device where part of the device is contained on each glass layer.

A method of fabrication of single or multi-layer photo-definable glass structure with a plurality of devices on each layer with copper paste metallization comprising of one or more, electronic, photonic, or MEMS device. The metallization process uses a metal paste that requires a thermal ramp rate of 10° C./min from 25° C. to 600° C., a 10 min hold at 600° C. and ramp down from 600° C. to 25° C. This approximate 35-minute annealing cycle is all accomplished in nitrogen to prevent oxidation of the copper. In general, the metallization thermal cycle induces a permanent random physical distortion and optical transmission change in the photo-definable glass structure. A process flow is required to minimize the time and temperature for the annealing cycle to melt and densify the copper paste into solid metallic structure while not exposing the glass to long duration time and temperature cycles.

The photo-definable glass is transparent to several parts of the electromagnetic spectrum. Several portions of the photo-definable glass' transparent electromagnetic spectrum are absorbed by copper and copper paste. The electromagnetic spectrum that is absorbed by metals and nominally transparent to a photo-definable glass enables the melting and densification of the copper paste metallization of a traditional glass or photo definable glass substrate. The electromagnetic spectrum that can achieve melting and densification of copper paste on a glass substrate includes but not limited to microwave frequency, visible, near infra-red and mid infra-red spectrum that can be generated by an inductive, microwave, or high intensity lamp.

### DESCRIPTION OF THE DRAWINGS

For a more complete understanding of the features and advantages of the present invention, reference is now made to the detailed description of the invention along with the accompanying figures and in which:

FIG. 1 shows a graph of the absorption spectra for copper.

FIGS. 2A and 2B show a graph of the absorption spectra for APEX® glass.

FIG. 3 shows a graph of the optical spectra for APEX® glass after different thermal cycling and UV exposure.

FIG. 4 shows a graph of the temperature cycle for a silicon substrate for a rapid thermal annealing source. FIG. 5 shows a graph of the optical spectra for a rapid thermal annealing source.

### DESCRIPTION OF EMBODIMENTS

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not restrict the scope of the invention.

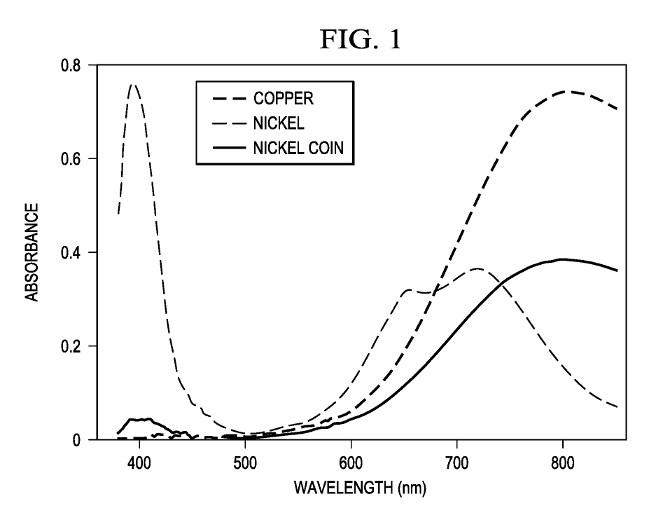

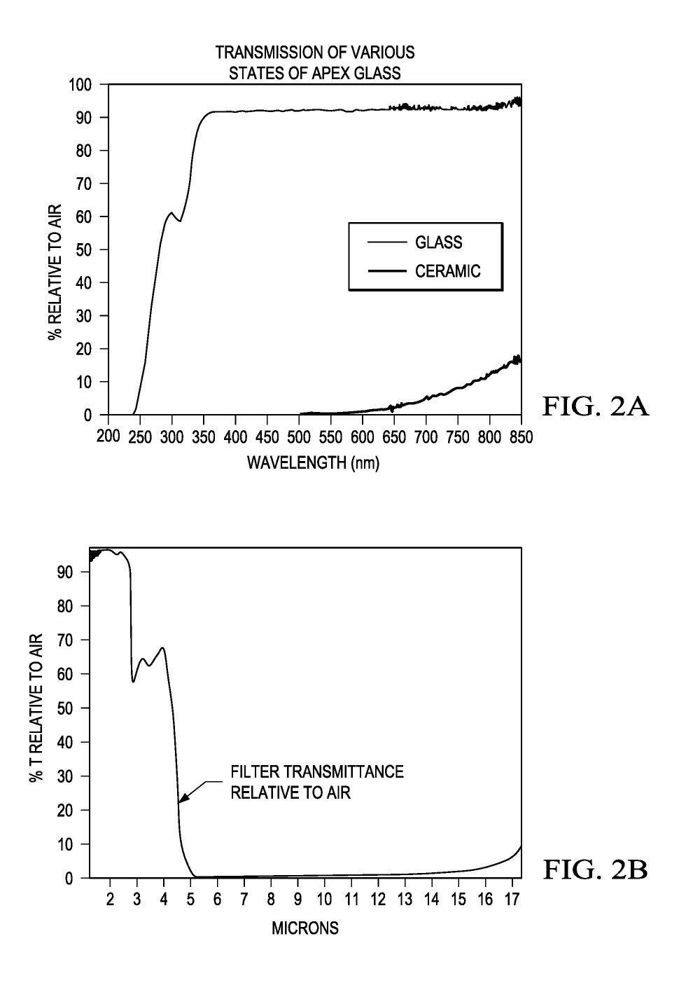

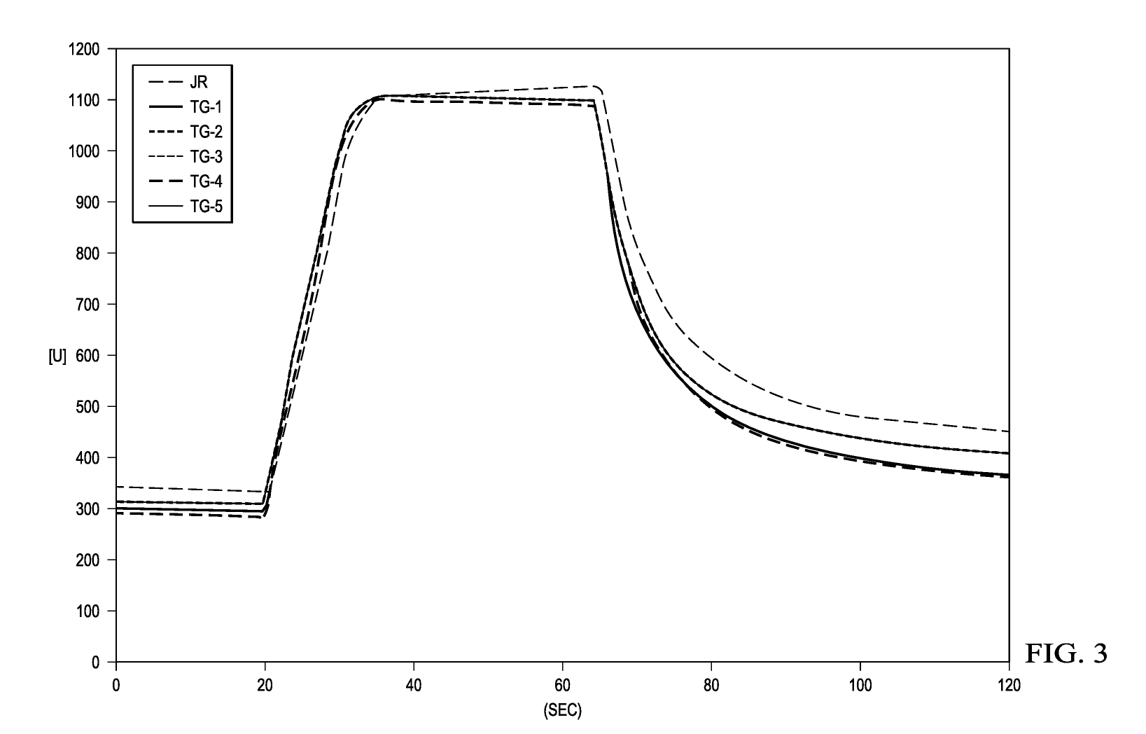

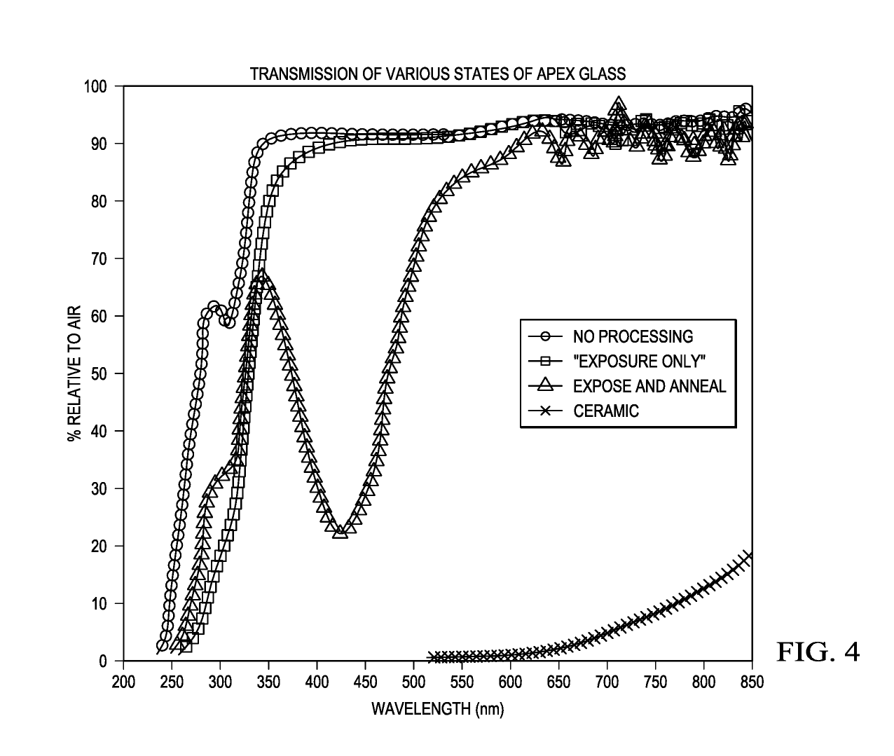

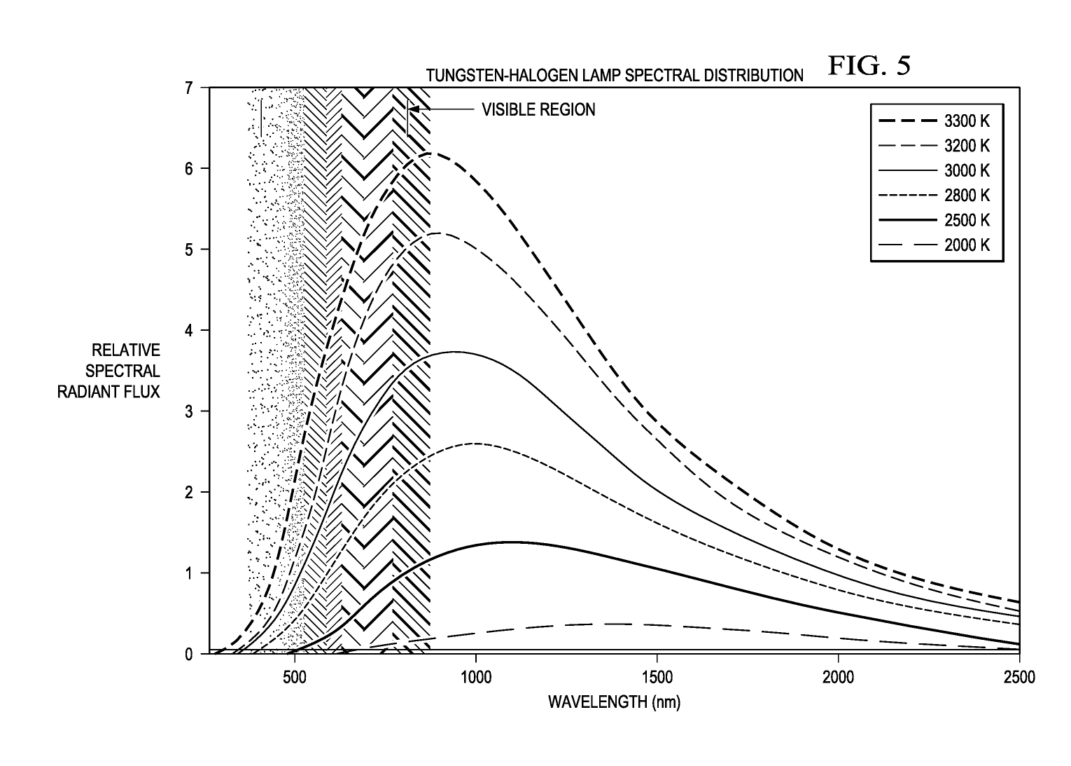

FIG. 1 shows a graph of the absorption spectra for copper. FIGS. 2A and 2B show a graph of the absorption spectra for APEX® glass. FIG. 3 shows a graph of the optical spectra for APEX® glass after different thermal cycling and UV exposure. FIG. 4 shows a graph of the temperature cycle for a silicon substrate for a rapid thermal annealing source. FIG. 5 shows a graph of the optical spectra for a rapid thermal annealing source.

A source of the electromagnetic spectrum that is absorbed by metals and is nominally transparent to a photo-definable glass enables the heating, melting and densification of the metal deposited from a paste deposition process on a traditional glass or photo definable glass substrate is preferably a high intensity tungsten filament lamp. High intensity tungsten filament lamps are the heating source used in rapid thermal annealing (RTA) or rapid thermal processing (RTP). The time at temperature is such that it does not change the position of the features on the substrate by greater 20 μm and the color shift of the glass is less than 75 nm. Experiments have shown that the time needs to be less than 10 min at 700° C. or a temperature time ratio of less than 70° C./min RTA is a process used in semiconductor device fabrication that consists of preferentially heating a single metal on a glass substrate or a stack of glass substrates.

Traditional RTA process can be performed by using either lamp based heating, a hot chuck, or a hot plate that a substrate. A hot chuck or a hot plate RTA will heat the substrate in addition to glass substrate. Lamp based heating RTA processes will heat the metal significantly more than the surrounding glass substrate allowing the metal to be heat-densified without inducing the permanent mechanical distortion or optical change in the glass substrate.

The electromagnetic spectrum that can achieve melting and densification of copper paste on a glass substrate includes but not limited to microwave frequency, visible, near infra-red and mid infra-red spectrum that can be generated by an inductive, microwave, or high intensity lamp.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for producing a fully dense metallized glass substrate where the metal is preferentially heated and or densified relative to the glass substrate comprising:
depositing a metal paste on the single or a multi-layer glass structure;
conducting a metallization thermal cycle with a thermal ramp rate of 10° C./min from 25° C. to 600° C., a 10 min hold at 600° C.; and ramp down from 600° C. to 25° C.; and
annealing the metal to the single or a multi-layer photo-definable glass structure under nitrogen to prevent oxidation of the metal, wherein the metallization thermal cycle induces a permanent random physical distortion and optical transmission change in the glass structure; wherein:
(a) a change in a position of the metal, the single or a multi-layer photo-definable glass structure, and one or more device structures after the metallization thermal cycle is less than 20 μm; and
(b) wherein a color of the glass substrate is not shifted greater than 75 nm, and
(c) wherein a temperature to time ratio does not exceed 70° C./min.

2. The method of claim 1, wherein the metal is copper, silver, platinum, gold, or a combination thereof.

3. The method of claim 1, wherein the glass is photo-definable.

4. The method of claim 1, wherein the glass substrate contains electronic, photonic, or MEMS devices.

5. A method of integrating two or more glass substrates where the metal structures are preferentially heated and or densified relative to the glass substrate inducing change in the position of structures of less than 20 μm and without significantly altering the color of the glass substrate, wherein a change in a position of structures of less than 20 μm and wherein a color of the glass substrate is not shifted greater than 75 nm, and wherein a temperature time ratio of does not exceed 70° C./min, by a method comprising:
depositing a metal paste on the single or a multi-layer glass structure;
conducting a metallization thermal cycle with a thermal ramp rate of 10° C./min from 25° C. to 600° C., a 10 min hold at 600° C.; and ramp down from 600° C. to 25° C.; and
annealing the metal to the single or a multi-layer photo-definable glass structure under nitrogen to prevent oxidation of the metal, wherein the metallization thermal cycle induces a permanent random physical distortion and optical transmission change in the glass structure.

6. The method of claim 5, wherein the metal is copper, silver, platinum, gold, or a combination thereof.

7. The method of claim 5, wherein the glass is photo-definable.

8. The method of claim 5, wherein the glass substrate contains electronic, photonic, or MEMS devices.

9. The method of claim 5, wherein the metals may reside partially through, fully through, in between, or on top of the glass-ceramic material, or a combination thereof.

10. A method for producing a single or a multi-layer glass structure with one or more devices on each of one or more layers with metal paste metallization comprising:
depositing a metal paste on the single or a multi-layer photo-definable glass structure;
conducting a metallization thermal cycle with a thermal ramp rate of 10° C./min from 25° C. to 600° C., a 10 min hold at 600° C.; and ramp down from 600° C. to 25° C.; and
annealing the metal to the single or a multi-layer photo-definable glass structure under nitrogen to prevent oxidation of the metal, wherein the metallization thermal cycle induces a permanent random physical distortion and optical transmission change in the photo-definable glass structure.

11. The method of claim 5, wherein the metal is copper, silver, platinum, gold, or a combination thereof.

12. The method of claim 10, wherein the metal is copper, silver, platinum, gold, or a combination thereof.

13. The method of claim 10, wherein the glass is photo-definable.

14. The method of claim 10, wherein the glass substrate contains electronic, photonic, or MEMS devices.

15. The method of claim 10, wherein metallization thermal cycle at least one of: (1) constrains a change in the relative change in position of the metal, the glass, and the one or more device structures to less than 20 μm, (2) wherein a color of the glass substrate is not shifted greater than 75 nm, or (3) wherein a temperature to time ratio does not exceed 70° C./min.
